(19) United States
(12) Patent Application Publication
(10) Pub. No.: US 2022/0314801 A1
(43) Pub. Date: Oct. 6, 2022

(54) OPERATING DEVICE FOR A VEHICLE AND METHOD FOR ADJUSTING AN OPERATING CHARACTERISTIC OF AN OPERATING DEVICE

(71) Applicant: ZF Friedrichshafen AG, Friedrichshafen (DE)

(72) Inventors: Fabian Schrader, Friedrichshafen (DE); Michael Pantke, Friedrichshafen (DE); Martin Ruider, Schwarzhofen (DE); Magnus Sprehe, Steinfeld (DE); Rainer Haevescher, Stemwede (DE); Artur Neumann, Kalletal (DE); Thorsten Sander, Rahden (DE); Georg Tenckhoff, Friedrichshafen (DE); Erwin Biegger, Wangen im Allgäu (DE)

(73) Assignee: ZF Friedrichshafen AG, Friedrichshafen (DE)

(21) Appl. No.: 17/640,540

(22) PCT Filed: Aug. 26, 2020
(86) PCT No.: PCT/EP2020/073855

§ 371 Date: Mar. 4, 2022

(30) Foreign Application Priority Data
Sep. 6, 2019 (DE) 10 2019 213 554.4

(51) Int. Cl. B60K 37/06; G05G 5/03; G06F 3/0362

(52) U.S. Cl. CPC B60K 37/06; G05G 5/03; G06F 3/0362; B60K 2370/126; B60K 2370/158

(57) ABSTRACT

An operating device may have a moving operating element, a housing a magnetorheological elastomer, and a coil. An end of the operating element may be supported in the housing. The magnetorheological elastomer may result in a first operating characteristic for operating the operating element in a resting state and a second operating characteristic for the operation in an activated state. The coil may generate a magnetic field that transfers the magnetorheological elastomer between the resting state and the activated state.

### RELATED APPLICATIONS

This application is a filing under 35 U.S.C. § 371 of International Patent Application PCT/EP2020/073855, filed Aug. 26, 2020, and claiming priority to German Patent Application 10 2019 213 554.4, filed Sep. 6, 2019. All applications listed in this paragraph are hereby incorporated by reference in their entireties.

### TECHNICAL FIELD

The present disclosure relates to an operating device for a vehicle and a method for adjusting an operating characteristic of an operating device.

### BACKGROUND

When a magnetorheological fluid (MRF) is subjected to a magnetic field obtained by feeding a current though a coil, the viscosity of the MRF is altered. As a result, end stops can be obtained and a component can be locked in place without a mechanism.

### BRIEF DESCRIPTION OF THE DRAWINGS

Exemplary embodiments of the invention presented herein are shown in the drawings, and explained in greater detail in the following description. Therein:

FIG. 1 shows a cross section of a vehicle with an operating device according to an exemplary embodiment;

FIG. 2 shows a cross section of an operating device according to an exemplary embodiment;

FIG. 3 shows a cross section of an operating device according to an exemplary embodiment; and

FIG. 4 shows a flow chart for a method for adjusting an operating characteristic of an operating device according to an exemplary embodiment.

### DETAILED DESCRIPTION

Based on the background discussed above, the present invention results in an improved operating device for a vehicle and an improved method for adjusting an operating characteristic for an operating device in accordance with the main claims. Advantageous embodiments can be derived from the dependent claims and the following description.

The advantages that can be obtained with the approach presented herein comprise an easily installed operating device, which can be locked in place in a robust manner, which exhibits very low wear. The magnetorheological elastomer can be quickly and easily installed. Advantageously, unlike with a magnetorheological fluid, no seals are needed. There is also very little abrasion with the use of a magnetorheological elastomer.

An operating device for a vehicle has a moving operating element, a housing, a magnetorheological elastomer, and a coil. A first end of the operating element is placed in the housing. With the magnetorheological elastomer a first operating characteristic is obtained for operating the operating element in a resting state, and in a second operating characteristic is obtained for the operation of the operating element in an activated state. The coil generates a magnetic field, which transfers the magnetorheological elastomer between the resting state and the activated state.

The operating device can be designed to operate an arbitrary function in the vehicle. The operating element can be manually operated by a user. A second end of the operating element can protrude from the housing to enable the operation thereof. By way of example, the operating device can be placed in the instrument panel, shifting lever, steering wheel, or center console in a vehicle. The resting state of the magnetorheological elastomer can be understood to be a state in which no magnetic field acts on the magnetorheological elastomer, i.e. no current flows through the coil. The activated state of the magnetorheological elastomer can be understood to be a state in which a magnetic field acts on the magnetorheological elastomer, i.e. a current flows through the coil. By applying the external magnetic field, viscoelastic or dynamic-mechanical properties of the magnetorheological elastomer can be quickly and reversibly altered, such that the shape of the magnetorheological elastomer changes between the resting state and the activated state. The operating device can thus be used as a switch, e.g. a rotary switch. The user can then feel when the operating element is locked in place in the activated state.

The use of a magnetorheological elastomer for obtaining different operating characteristics for the operation of the operating element makes it possible to obtain different types of tactile feedback for the user during the operation, as well as additional or alternative locking functions for the operating element.

The magnetorheological elastomer can contain a material that can be expanded by the magnetic field, for example. As a result, the magnetorheological elastomer can be deflected or deformed by the magnetic field in a defined direction, in order for the magnetorheological elastomer to come in contact with or press against the operating element in the activated state. The magnetorheological elastomer can contain numerous iron particles for this, for example.

In the resting state, the magnetorheological elastomer can be spaced apart from the operating element, in order to allow operation without resistance as the first operating characteristic, and the magnetorheological elastomer can come in mechanical contact with the operating element in the activated state, in order to generate a resistance during the operation as the second operating characteristic. In one embodiment, the resistance can result in a more difficult operation, or even a blocking of the operation of the operating element.

According to one embodiment, the magnetorheological elastomer can be spaced apart from the first end of the operating element in the resting state, and come in mechanical contact with the first end when in the activated state. As a result, the magnetorheological elastomer can be protected inside the housing, which also contains the first end. By way of example, the magnetorheological elastomer can be placed such that it comes in contact with the first end from one side when in the activated state, which is opposite another side, at which the first end is supported inside the housing. The magnetorheological elastomer can therefore clamp the first end between the magnetorheological elastomer and a bearing. The magnetorheological elastomer can be contained in the housing.

The first end can comprise a rotor disk on the operating element. By way of example, the magnetorheological elastomer can come in vertical or horizontal contact, in the activated state, with a section of the rim of, or encompass, the rotor disk. The operating element can be integrally formed, with the rotor disk extending perpendicular to the second end. The first end of the operating element can be rotatably supported in the housing. By rotating the second end, the first end can be rotated in a corresponding manner.

According to one embodiment, the coil can encompass the first end and/or the magnetorheological elastomer. This allows the coil to be adjacent to the magnetorheological elastomer, such that it can be effectively converted from one state to the other. The magnetorheological elastomer can be annular. This results in uniform tactile feedback during the second operating characteristic, and a particularly robust locking of the operating element in place, e.g. by coming in contact with the entire rim of the rotor disk when in the activated state.

It is also advantageous if the operating device has a power source for supplying a current to the coil in order to generate the magnetic field.

A method for adjusting the operating characteristics of the operating device described above contains a step for activating and a step for deactivating the operating device. In the activating step, the coil is activated to generate a magnetic field, in order to transfer the magnetorheological elastomer from the resting state to the activated state, in order to obtain the second operating characteristic for the operation of the operating device. In the activating step, the coil can be subjected to a current from a power source, for example. In the deactivating step, the coil is deactivated, in order to transfer the magnetorheological elastomer from the activated state to the resting state, in order to obtain the first operating characteristic for the operation of the operating device. In the deactivating step, the supply of current to the coil from a power source is deactivated.

This method can be implemented through software or hardware, or with a mixture of software and hardware, e.g. in a control unit.

Referring now to the figures, the same or similar reference symbols shall be used for the elements shown in the drawings that have similar functions in the following description of preferred exemplary embodiments of the present invention, although the descriptions of these elements shall not be repeated.

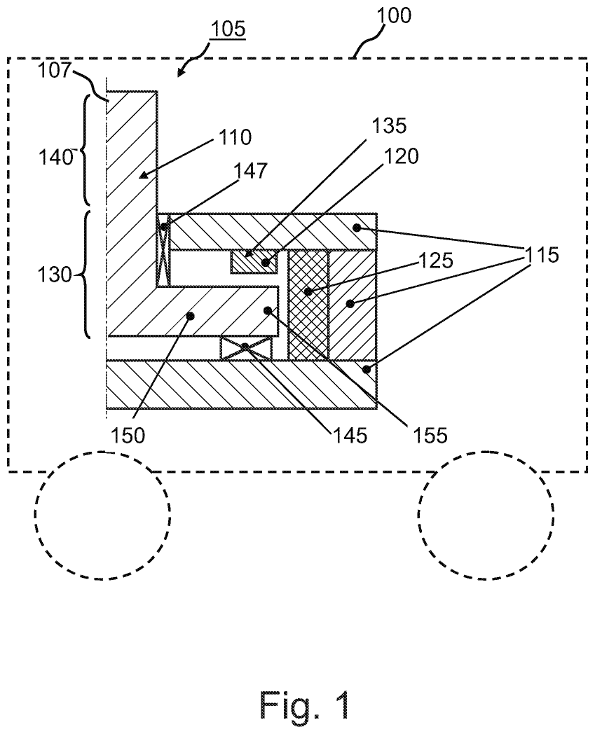

FIG. 1 shows a purely schematic cross section of a vehicle 100 with an operating device 105 according to an exemplary embodiment. Only half of the operating device 105 according to this exemplary embodiment is shown, cut along a line 107.

The operating device 105 is placed according to this exemplary embodiment in or on the vehicle 100, and is designed to operate an arbitrary function of the vehicle 100, e.g. by adjusting this function. By way of example, the operating device 105 can be operated manually by an occupant in the vehicle 100. According to one exemplary embodiment, the operating device 105 is used to adjust, activate, or deactivate an assistance function or entertainment function in the vehicle 100.

The operating device 105 has a moving operating element 110, a housing 115, a magnetorheological elastomer 120, and a coil 125. A first end 130 of the operating element 110 is in the housing 115. In this manner, the operating element 110 can be moved in relation to the housing 115 when operated by an occupant. The magnetorheological elastomer 120 is designed to obtain a first operating characteristic for an operation of the operating element 110 in a resting state, and a second operating characteristic for the operation thereof in an activated state. The coil 125 generates a magnetic field, which converts the magnetorheological elastomer 120 from the resting state 135 to the activated state.

The operating element 110 in this exemplary embodiment forms a rotary knob. The operating element 110 can have an integral design, or comprise multiple parts. The operating element 110 in this exemplary embodiment has a T-shaped cross section, by way of example. Alternatively, the operating element 110 can also be in the form of a pin with a rectangular cross section, or an L-shaped cross section. According to this exemplary embodiment, a second end 140 of the operating element 110 protrudes in a straight line out of the housing 115, such that it can be operated by the occupants of the vehicle. The operating element 110 is supported in the housing by a first bearing 145 and a second bearing 147.

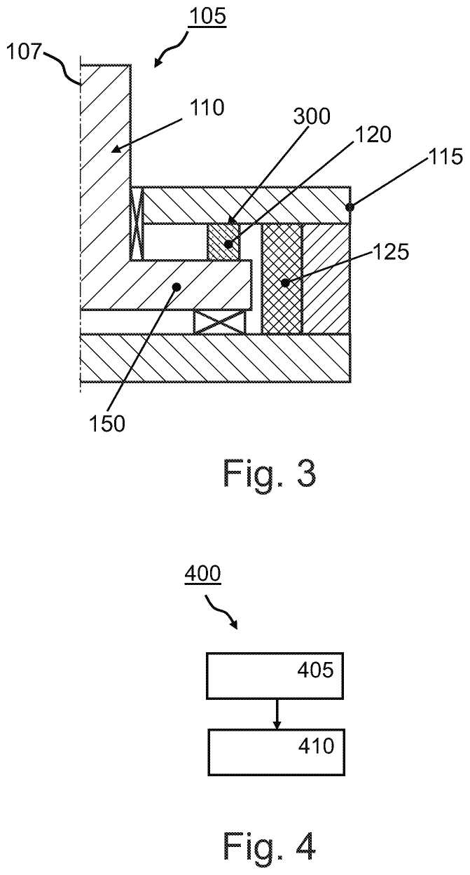

The magnetorheological elastomer 120 in this exemplary embodiment has a material that can be expanded by the magnetic field. According to this exemplary embodiment, the magnetorheological elastomer 120 contains numerous iron particles. In the resting state 135 shown here, the magnetorheological elastomer 120 is spaced apart from the operating element 110, to allow operation thereof without resistance as the first operating characteristic. In the activated state shown in FIG. 3, the magnetorheological elastomer 120 is in mechanical contact with the operating element 110, to generate a resistance during the operation thereof as the second operating characteristic.

According to this exemplary embodiment, the magnetorheological elastomer 120 is spaced apart from the first end 130 of the operating element 110 in the resting state 135. According to an alternative exemplary embodiment, the magnetorheological elastomer 120 is in mechanical contact with the first end 130 in the activated state. The magnetorheological elastomer 120 is contained in the housing 115 in this exemplary embodiment, on a flat cover element of the housing 115, such that the second end 140 protrudes from the housing 115.

According to this exemplary embodiment, the magnetorheological elastomer 120 is placed such that it comes in contact with one side of the first end 130 in the activated state, which is opposite another side, with which the first end 130 is supported in the housing 115 by means of the first bearing 145. The magnetorheological elastomer 120 is placed such that the first end 130 is clamped between the magnetorheological elastomer 120 and the first bearing 145 in the activated state.

The first end 130 comprises a rotor disk 150 in this exemplary embodiment. The rotor disk 150 is therefore located inside the housing 115. The rotor disk 150 forms an annular extension that extends perpendicular to a longitudinal axis of the straight second end 140 of the operating element 110. The operating element 110 therefore has a greater circumference in the region of the rotor disk 150 than in the region of the second end 140. By way of example, the rotor disk 150 has a thickness of less than 5 millimeters. The magnetorheological elastomer 120 comes in contact vertically with a section of the rim 155, or encompasses the rotor disk 150 in the activated state. The first end 130 is supported in the housing 115 in this exemplary embodiment such that it can rotate.

According to one exemplary embodiment, the operating device 105 has a sensor that is designed to detect a position, e.g. a rotational angle, of the operating element 110. There is a transmitter on the rotor disk 140 for this. Such a transmitter is formed by way of example by a magnet or a mechanical latching element. A position or operation of the operating element 110 can be detected as a result, and an electrical signal can be emitted that indicates the position or operation of the operating element 110.

The coil 125 in this exemplary embodiment is adjacent to the rim section 155 and/or the magnetorheological elastomer 120. As a result, a magnetic field generated by the coil 125 can penetrate the magnetorheological elastomer 120.

The operating device 105 also has a power source in this exemplary embodiment, which supplies a current to the coil 120 in order to generate the magnetic field.

The operating device 105 presented herein therefore has an operating element 110 that can be programmed by means of a magnetorheological elastomer 120.

The operating device 105 generates a magnetic field on the basis of the magnetorheological elastomer 120, “MRE,” via a current supplied to the coil 120, which causes a change in the shape of the MRE. This results in end stops, and/or a locking in place, without a mechanism.

The magnetorheological elastomer 120 advantageously exhibits no abrasion, or very little in comparison with a magnetorheological fluid (MRF) when in operation. There is no filling process in the installation of the operating device 105, and the system does not need to be sealed, because the magnetorheological elastomer is not liquid.

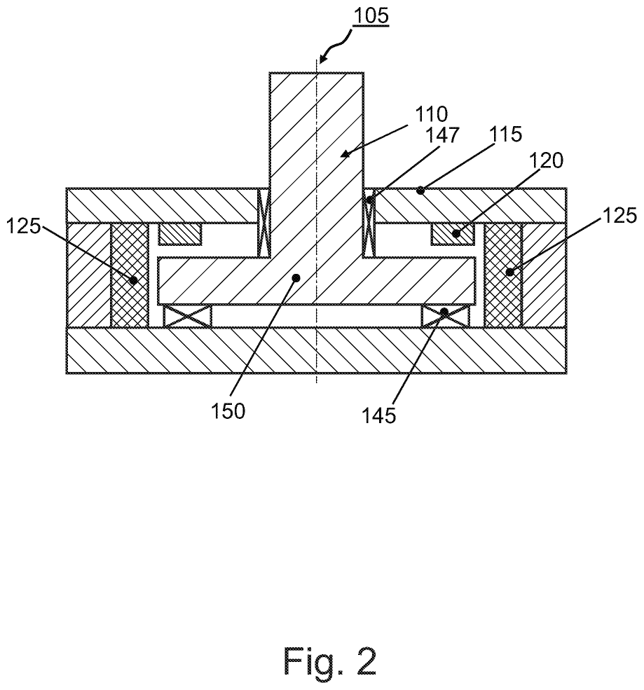

FIG. 2 shows a cross section of an operating device 105 according to an exemplary embodiment. This can be the operating device 105 shown in FIG. 1, the other half of which is shown in this exemplary embodiment.

The housing in this exemplary embodiment is cylindrical and/or box-shaped, with an opening through which the second end of the operating element 110 is inserted. The second bearing 147 is located in the opening in a gap between the operating element 110 and the housing 115. The second bearing 147 encompasses the pin-shaped part of the first end 130 in an annular manner. The first bearing 145 is located between a base section of the housing 115 lying opposite the opening, and the rotor disk 150.

The coil 125 encompasses the first end and/or the magnetorheological elastomer 120 in an annular manner in this exemplary embodiment. The magnetorheological elastomer 120 is annular in this exemplary embodiment. An outer diameter of the magnetorheological elastomer 120 substantially corresponds to the outer diameter of the rotor disk 150 in this exemplary embodiment.

FIG. 3 shows a cross section of an operating device 105 according to an exemplary embodiment. This can be the operating device 105 described in reference to FIG. 1 or 2, with the difference that the magnetorheological elastomer 120 is in the activated state 300 in this exemplary embodiment.

The magnetorheological elastomer 120 is in contact with the operating element 110 in the activated state 300 in this exemplary embodiment. According to this exemplary embodiment, the resistance obtained in the activated state 300 results in a more difficult operation or even a blocking of the operation of the operating element 110. The resistance is generated in that the magnetorheological elastomer 120 clamps the rotor disk 150 to the housing 115.

The activated state 300 is obtained by supplying a current to the coil 125, which generates a magnetic field. This magnetic field acts on the magnetorheological elastomer 120 in this exemplary embodiment. The magnetorheological elastomer 120 expands along the field lines as a result of the iron particles contained therein and exerts a force on the rotor disk 150 in this exemplary embodiment. This results in a braking torque, preventing rotation of the operating element 110. The coil 125 can be activated and deactivated arbitrarily, in order to cause an expansion or shrinking of the magnetorheological elastomer 120. This results in a locking function without any mechanisms that would otherwise be necessary for this.

Depending on the force exerted by the magnetorheological elastomer 120 on the rotor disk 150, the rotor disk 150 can be fixed in place in the activated state, or more difficult to move, from the perspective of an occupant operating the operating element 110. According to one exemplary embodiment, there are different activated states, which differ in terms of the force exerted by the magnetorheological elastomer 120 on the rotor disk 150. These can be obtained through different currents applied to the coil 125.

Alternatively to the exemplary embodiments shown herein, the magnetorheological elastomer 120 can also be placed elsewhere. Regardless of the placement, the magnetorheological elastomer 120 can be a single piece, or it can be divided up and placed on two or more elements.

If the operating element 110 is supported such that it moves linearly in the housing 115, the magnetorheological elastomer 120 can be used in the same manner to allow or prevent a linear movement of the operating element 110.

FIG. 4 shows a flow chart for a method 400 for adjusting an operating characteristic of an operating device according to an exemplary embodiment. This can be the operating device described in reference to any of the FIGS. 1 to 3.

The method 400 comprises a step 405 for activating and a step 410 for deactivating the operating device. In the activating step 405, the coil is activated to generate a magnetic field in order to transfer the magnetorheological elastomer from the resting state to the activated state to obtain the second operating characteristic for the operation of the operating device. In the activating step 405, the coil is supplied with a current by a power source in this exemplary embodiment, in order to activate the coil. In the deactivating step 410, the coil is deactivated, in order to transfer the magnetorheological elastomer from the activated state to the resting state to obtain the first operating characteristic for the operation of the operating device. In the deactivating step 410, the current supply from the power source is deactivated in order to deactivate the coil.

According to one exemplary embodiment, step 405 is carried out when the operating element in the operating device has assumed a predefined position, or has moved in a predefined way. In this manner, a user can be given the feeling that the operating element is locked in place.

If an exemplary embodiment comprises an “and/or” conjunction between a first feature and a second feature, this is to be read to mean that the exemplary embodiment contains both the first feature and the second feature in one embodiment, and contains either just the first feature or just the second feature in another embodiment.

### REFERENCE SYMBOLS

100 vehicle
105 operating device
107 cutting line
110 operating element
115 housing
120 magnetorheological elastomer
125 coil
130 first end
135 resting state
140 second end
145 first bearing
147 second bearing
150 rotor disk
155 rim section
300 activated state
400 method for adjusting an operating characteristic
405 activation step
410 deactivating step

1. An operating device for a vehicle, the operating device comprising:
a moving operating element;
a housing wherein an end of the operating element is supported;
a magnetorheological elastomer, which has a first operating characteristic for operating the operating element in a resting state, and a second operating characteristic for the operation thereof in an activated state; and
a coil for generating a magnetic field, which transfers the magnetorheological elastomer between the resting state and the activated state.

2. The operating device according to claim 1, wherein the magnetorheological elastomer comprises a material that can be expanded by the magnetic field.

3. The operating device according to claim 1, wherein the magnetorheological elastomer contains numerous iron particles.

4. The operating device according to claim 1, wherein the magnetorheological elastomer is spaced apart from the operating element in the resting state, and allows the operation of the operating element without resistance as the first operating characteristic, and is in mechanical contact with the operating element in the activated state, and generates a resistance in the operation of the operating element as the second operating characteristic.

5. The operating device according to claim 1, wherein the magnetorheological elastomer is spaced apart from the end of the operating element in the resting state, and is in mechanical contact with the end in the activated state.

6. The operating element according to claim 5, wherein the end comprises a rotor disk for the operating element.

7. The operating device according to claim 1, wherein the end of the operating element is rotatably supported in the housing.

8. The operating device according to claim 1, wherein the coil encompasses the end and/or the magnetorheological elastomer in an annular manner.

9. The operating device according to claim 1, wherein the magnetorheological elastomer is annular.

10. The operating device according to claim 1, with a power source for supply a current to the coil for generating the magnetic field.

11. A method for adjusting an operating characteristic of an operating device, wherein the operating device comprises a housing, a magnetorheological elastomer having a first operating characteristic for a resting state and a second operating characteristic for an activated state, and a coil for generating a magnetic field for transferring the magnetorheological elastomer between the resting state and the activated state, wherein the method comprises the following steps:
activating a coil to generate a magnetic field to transfer the magnetorheological elastomer from a resting state to an activated state, in order to obtain the second operating characteristic for the operation element; and
deactivating the coil to transfer the magnetorheological elastomer from the activated state to the resting state, in order to obtain the first operating characteristic for the operation of the operating element.
